(19) United States
(12) Patent Application Publication
(10) Pub. No.: US 2016/0309695 A1
(43) Pub. Date: Oct. 27, 2016

(54) ELECTRONIC INSECT KILLING APPARATUS

(71) Applicant: Intellectual Solutions, Inc., Eatontown, NJ (US)

(72) Inventor: Mervin A. Dayan, Oakhurst, NJ (US)

(21) Appl. No.: 15/137,565

(22) Filed: Apr. 25, 2016

Related U.S. Application Data
(60) Provisional application No. 62/152,180, filed on Apr. 24, 2015.

(51) Int. Cl. A01M 3/02; A63B 60/00; A63F 9/24

(52) U.S. Cl. CPC A01M 3/025; A63F 9/24; A63B 60/00

(57) ABSTRACT

In one embodiment, the invention can be an electronic insect killing apparatus including a handle; and a racket assembly coupled to and extending upward from the handle, the racket assembly comprising a frame forming a central opening; an electrically conductive grid assembly positioned within the central opening of the frame; and an insulator assembly positioned within the grid assembly and comprising insulating members, the insulating members forming zones within the central opening, wherein a unique scoring indicium is associated with each zone,

### CROSS REFERENCE TO RELATED APPLICATIONS

The present application claims the benefit of U.S. Provisional Patent Application No. 62/152,180 filed Apr. 24, 2015, the entirety of which is incorporated herein by reference.

### BACKGROUND

Electronic insect killing devices have existed in different forms. Traditional bug zappers are sizeable appliances that are powered by mains electricity and are typically hung. In such zappers, a light source attracts bugs and, when sufficiently close, the bugs are electrocuted. By contrast, electronic flyswatters are handheld and battery-powered, and are generally used to swat at flying insects. An electronic insect killing device is needed that provides an enhanced user experience.

### BRIEF SUMMARY

The present invention is directed to an electronic insect killing apparatus. In one aspect, an electronic insect killing apparatus includes a handle; and a racket assembly coupled to and extending, upward from the handle, the racket assembly comprising a frame forming a central opening; an electrically conductive grid assembly positioned within the central opening of the frame; and an insulator assembly positioned within the grid assembly and comprising insulating members, the insulating members forming zones within the central opening, wherein a unique scoring indicium is associated with each zone.

In another aspect, an electronic insect killing apparatus includes a handle comprising a display; and a racket assembly coupled to and extending upward from the handle, the racket assembly comprising: a grid assembly comprising three electrically conductive grid sub-assemblies, each grid sub-assembly comprising a first grid and a second grid, the first and second grids having differing electrical charges; and an insulator assembly comprising two insulator members, each insulator member configured to separate two of the three grid sub-assemblies, the insulating members forming zones within the racket assembly, wherein a unique scoring indicium is associated with each zone.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front view of an electronic insect killing apparatus in accordance with an embodiment of the present disclosure.

FIG. 2 is a rear view of the electronic insect killing apparatus of FIG. 1.

FIG. 3 is a side view of the electronic insect killing apparatus of FIG. 1.

FIG. 4 is a cross-sectional view taken along line IV-IV of FIG. 1.

FIG. 4A is an enlarged version of area IV-A of FIG. 4.

FIG. 5 is a front view of an electronic insect killing apparatus in accordance with a second embodiment of the present invention.

FIG. 6 is a cross-sectional view taken along line VI-VI of FIG. 5.

FIG. 6A is an enlarged version of area VI-A of FIG. 6.

FIG. 7 is a block diagram of an electrical circuit in accordance with the electronic insect killing apparatus of the second embodiment of the present invention.

FIG. 8A is a cross-sectional view of an electronic insect killing apparatus in accordance with a third embodiment of the present invention.

FIG. 8B is an enlarged version of the area VIII-B of FIG. 8A.

### DETAILED DESCRIPTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of the exemplary embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top,” “bottom,” “front,” “back,” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” “secured” and similar refer to a relationship wherein structures are secured or attached to one another either directly or indirectly through intervening structures, as well as both movable or rigid attachments or relationships, unless expressly described otherwise. Moreover, the features and benefits of the invention are described by reference to the exemplary embodiments illustrated herein. Accordingly, the invention expressly should not be limited to such exemplary embodiments, even if indicated as being preferred. The discussion herein describes and illustrates some possible non-limiting combinations of features that may exist alone or in other combinations of features. The scope of the invention is defined by the claims appended hereto.

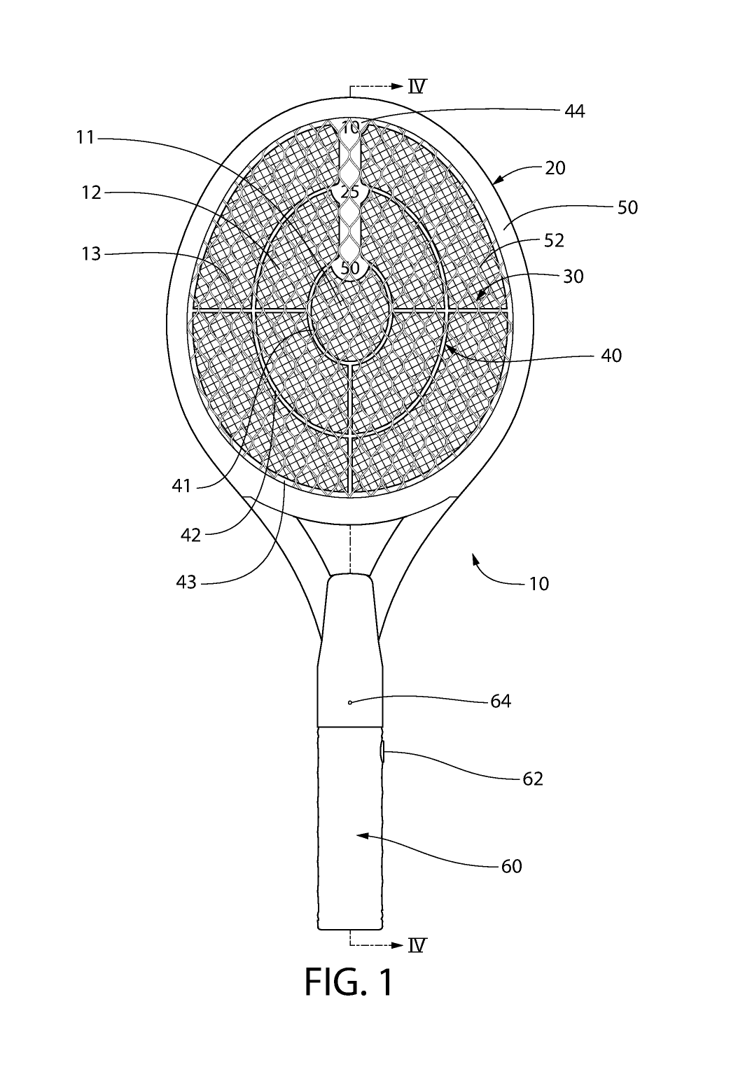

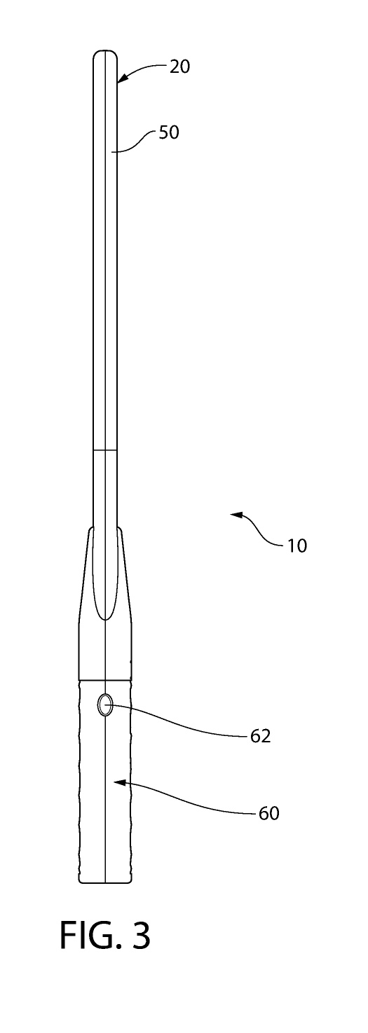

FIGS. 1-4A show an electronic insect killing apparatus 10 in accordance with a first embodiment of the present invention. As is shown, the electronic insect killing apparatus 10 comprises a handle 60, as well as a racket assembly 20 coupled to and extending upward from the handle 60. The racket assembly 20 comprises a frame 50, a grid assembly 30, and an insulator assembly 40, which will be discussed in further detail below.

In the exemplified embodiment, the handle 60, frame 50, and insulator assembly 40 are made of a hard plastic material. In other embodiments, the handle and racket assembly can be made of other materials sufficient for providing the necessary structural support for the electronic insect killing apparatus 10, provided the frame 50 and insulator assembly 40 comprise a dielectric material sufficient to enable them to prevent the flow of electricity. The handle 60 can include a soft overlayer to provide comfort and/or grip for the user handling the apparatus 10.

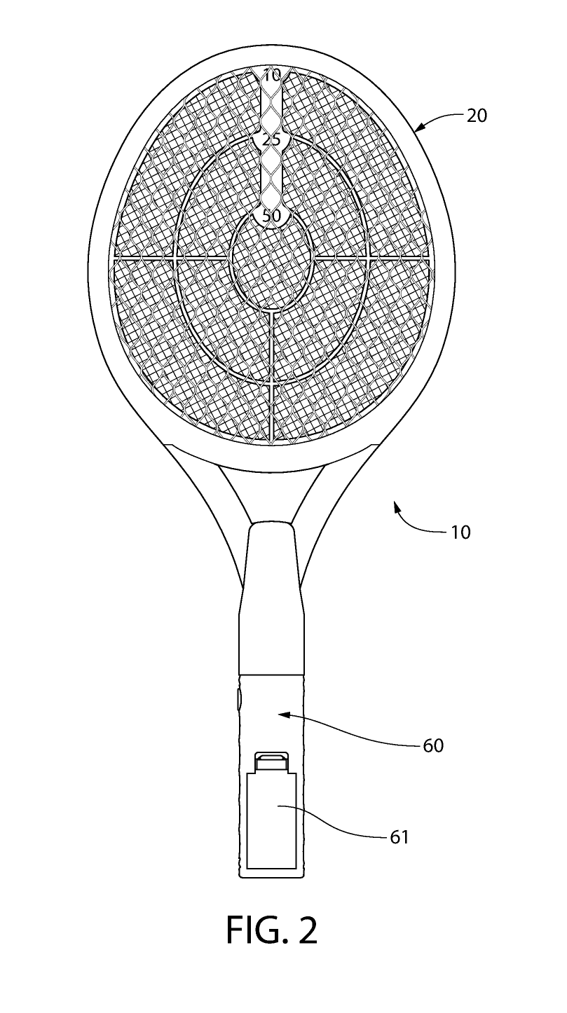

In the exemplified embodiment, a power source 66 is disposed within a housing of the handle 60. In this embodiment, the power source 66 is two AA (“double A”) batteries. The batteries can be inserted using, the battery compartment 61 (shown in FIG. 2). In other embodiments, the invention can use alternative power sources, such as other battery types (including AA, AAA, 9V batteries), provided the circuit of the apparatus 10 is capable of providing a sufficiently high voltage for electrocuting insects.

Returning to FIG. 1, the racket assembly 20 of the exemplified embodiment comprises an insulating frame 50 forming a central opening 52. The racket assembly 20 further comprises an electrically conductive grid assembly 30 positioned within the central opening 52 of the frame 50 and operably coupled to the power source 66. As will be discussed in further detail below, the electrically conductive grid assembly 30 provides an electrical charge for electrocuting an insect. The discussion below describes an exemplified embodiment for such an electrically conductive grid assembly 30, though any well-known arrangement using an electrically conductive grid to electrocute an insect could be considered an electrically conductive grid assembly.

The grid assembly 30 is activated by pressing the power button 62 located on the handle 60 of the apparatus 10. In the exemplified embodiment, the grid assembly 30 is only connected to the power source 66 and thereby activated when the power button 62 is held in a pressed down position. When the power button 62 is released, the grid assembly 30 is no longer active. This ensures that the grid assembly 30 does not remain active when the apparatus 10 is put down. In other embodiments, the grid assembly can be activated by the power button being pressed and can remain active until the power button is pressed again. In yet other embodiments, any switch assembly can be used to activate and deactivate the grid assembly (such as a slide-actuated switch), and the power button or switch can be in a variety of locations on the apparatus (such as on the racket assembly).

In the exemplified embodiment, a light 64 is provided in the handle 60 that illuminates when the grid assembly 30 is activated. Such a light 64 provides the user notice that the grid assembly 30 is active. In other embodiments, this light can be omitted.

The exemplified embodiment further comprises a circuit 65 located within the handle 60 and operably coupled to the electrically conductive grid assembly 30 and the power source 66. In other embodiments, the circuit 65 can be located outside the handle 60, for example in the insulating frame or in another housing. The circuit 65 is described in further detail below.

The insulator assembly 40 is positioned within the central opening 52 of the frame 50. The insulator assembly 40 can include one or more insulator members. In the exemplified embodiment, the insulator assembly 40 includes three insulator members: a first insulator member 41, a second insulator member 42, and a third insulator member 43.

The insulator members of the insulator assembly 40 can form zones. In the exemplified embodiment, the first insulator member 41 forms a first zone 11, the first and second insulator members 41, 42 form a second zone 12, and the second and third insulator members 42, 43 form a third zone 13. Each zone is associated with a scoring indicium 44. In the exemplified embodiment, the first zone 11 includes a first scoring indicium of “50,” the second zone 12 includes a second scoring indicium of “25,” and the third zone 13 includes a third scoring indicium of “10.” A user of the apparatus 10 can attempt to contact an insect within the zone associated with the highest score. In the exemplified embodiment, a user would attempt to kill an insect close to the center of the racket assembly 20, such zones being associated with a higher score. In other embodiments zones and associated scoring indicium can be provided in a variety of locations and shapes within the central opening 52 of the frame 50. Further, scoring indicia can take non-numerical values such as letters, symbols, or words.

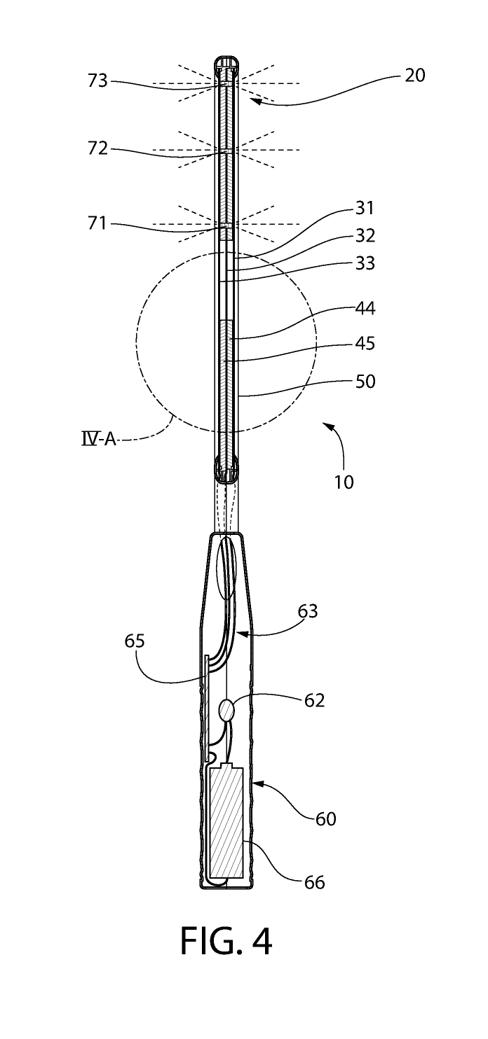

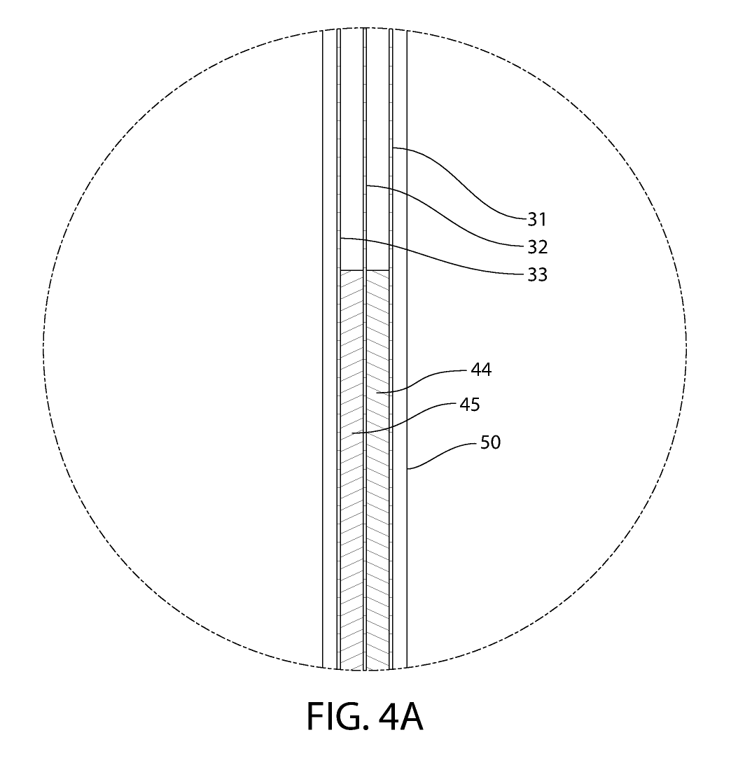

Referring now to FIG. 4, a cross-sectional view taken along line IV-IV of FIG. 1 is provided. As is shown, the racket assembly 20 can include light sources. In the exemplified embodiment, there are three light sources: a first light source 71, a second light source 72, and a third light source 73. The lights sources are light emitting diodes (“LEDs”). The light sources are associated with the scoring indicia, and when an insect is killed with the apparatus 10, one of the light sources can light the relevant scoring indicia. The lights can be powered by the power source 66 and the circuit 65 can be configured to instruct the lights sources to illuminate when an insect has been electrocuted. When the power button 62 is pressed, electrical wires 63 disposed in the handle 60 and insulating frame 50 can operably couple the light sources to the power source 66. The wires 63 can pass through the insulator assembly 40. The light sources can be disposed in or on the insulator assembly 40 such that light from the light sources can be seen by the user. The light sources can be LEDs, light bulbs, or any other devices capable of providing electromagnetic radiation. Further, the light sources can be provided in other locations on the rackets, such as circumferentially around the insulating members or elsewhere in the racket assembly 20.

As is further shown in FIG. 4, the grid assembly 30 of the exemplified embodiment includes three conductive grids—a front grid 33, a center grid 32, and a back grid 31. Further, the insulator assembly 40 includes a front insulator assembly 45 and a back insulator assembly 44 for separating the grids from each other.

FIG. 4A is an enlarged version of area IV-A of FIG. 4. As is shown, the front insulator assembly 45 separates the front grid 33 from the center grid 32. Similarly, the back insulator assembly 44 separates the back grid 31 from the center grid 32. The front insulator assembly 45 can include insulating members that intersect one another such that the front insulator assembly 45 comprises a single piece of plastic. The scoring indicia can also form part of this single piece of plastic. The foregoing can also be true of the back insulator assembly 44. The insulating members provide insulation such that components of the electrically conductive grid assembly 30 remain spaced sufficiently apart such that electrons do not flow between them. In other embodiments, insulating members can be located on the exterior of the electrically conductive grid assembly.

In the exemplified embodiment, the front grid 33 has a negative charge, the back grid 31 has a negative charge, and the center grid 32 has a positive charge, the center grid 32 positioned between the front and back grids. The grids can be of any pattern provided they provide space for an insect to make simultaneous contact with the center grid 32 and one of the other grids, in other embodiments, the grid assembly can have less or more grids, such as two grids of differing electrical charge.

In the exemplified embodiment, when switched on, the circuit 65 takes power from the two AA batteries in series and boosts the voltage. The boosted voltage can be any voltage sufficient to electrocute the targeted insect. This voltage is then provided to the center grid (“positive grid”). The front and back grids (the “negative grids”), by contrast, are connected with the negative terminal of the power source 66. The positive grid is separated from the negative grids at a sufficient distance to prevent shorting the circuit 65 during normal handling. But when an insect makes contact with the positive grid and one of the negative grids, the insect creates a low resistance path in between the positive grid and negative grid such that electricity passes through the insect and the insect is electrocuted. In other embodiments, the grids can be of any respective electrical charges sufficient to electrocute an insect when an insect comes in contact with two of the grids. For example, the outer grids can be positively charged and the center grid can be negatively charged.

In the exemplified embodiment, the first, second, and third grids are planar. In alternative embodiments, the grids could take non-planar shapes provided that the grids are a sufficient distance apart to both (1) allow insects to contact a positive and negative grid to be electrocuted and (2) prevent a short during normal handling.

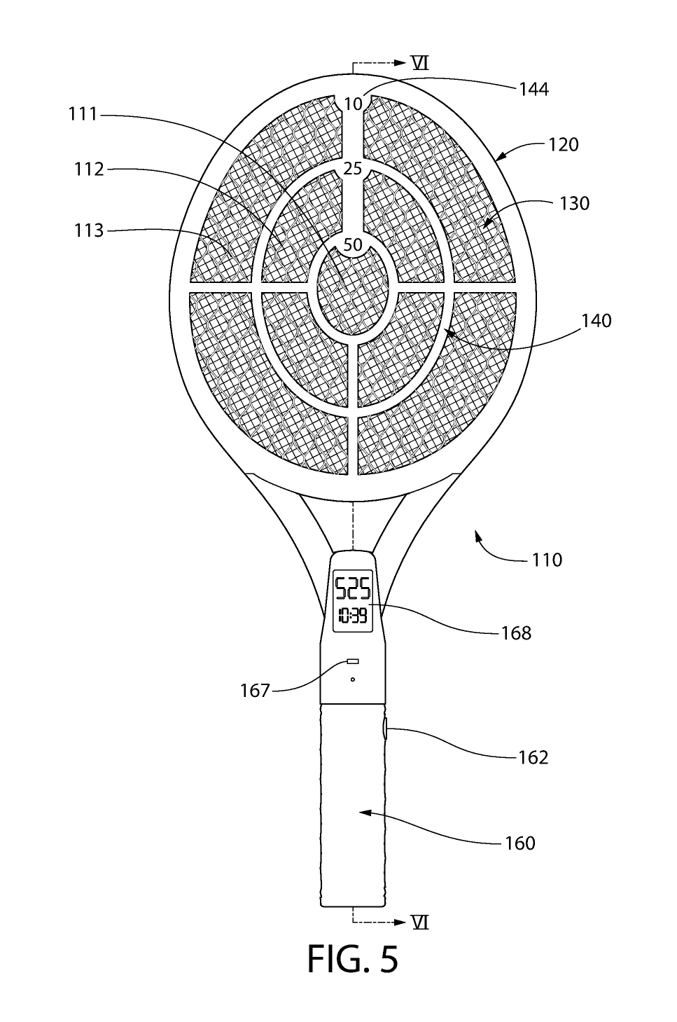

FIGS. 5-7 show an electronic insect killing apparatus 110 in accordance with a second embodiment of the present invention. In this embodiment, the apparatus 110 can determine the zone in which an insect has been electrocuted. FIG. 5 shows an apparatus 110 with a handle 160 and racket assembly 120. The racket assembly 120 includes a grid assembly 130 and an insulator assembly 140. The insulator assembly 140 includes scoring indicium 144. Further, the insulator assembly 140 forms a first zone 111, a second zone 112, and a third zone 113. In this embodiment, part of the insulator assembly is located outside the outer grid assemblies, as will be explained in further detail below. The handle 160 includes a display 168A (e.g., an LED display) that can indicate the number of “points” a user has scored and an indication of time elapsed or time remaining. The handle 160 further includes a grid switch 162 and a display switch 167. The grid switch 162 can activate the grid assembly in a manner similar to the power button discussed above. The display switch 167 can activate the display and light sources as discussed below. In this embodiment, the display switch 167 is a slide switch, but the display switch can be any type of electronic switch. In other embodiments, the functionality of the grid switch and display switch can be combined into one switch.

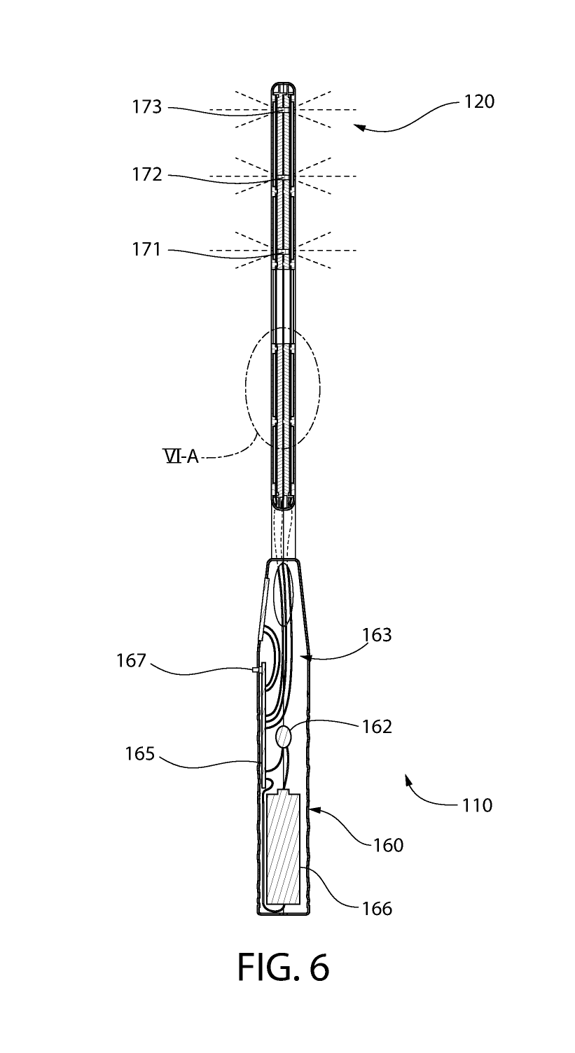

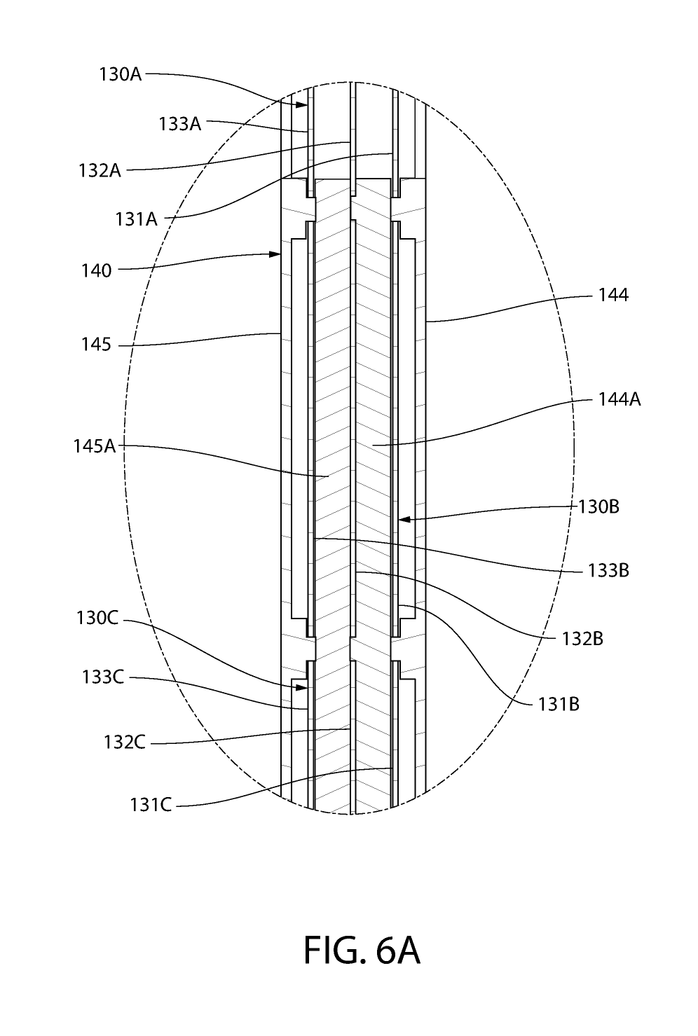

FIG. 6 is a cross-sectional view taken along line VI-VI of FIG. 5. This figure shows that the handle 160 includes a power source 166, a circuit 165, and wires 163. The wires 163 can connect the circuit 165 and power source 166 to the grid assembly 130 and lights sources 171, 172, 173 through the insulator assembly 140. The insulating members can be configured to receive the wires as necessary to transfer electricity to the intended destinations.

FIG. 6A is an enlarged version of area VI-A of FIG. 6. This figure shows that the grid assembly has three grid sub-assemblies, each zone having its own grid sub-assembly. The first zone grid sub-assembly 130A has a first zone front grid 133A, a first zone center grid 132A, and a first zone back grid 131A. The second zone grid sub-assembly 130B has a second zone front grid 133B, a second zone center grid 132B, and a second zone back grid 1318. The third zone grid sub-assembly 130C has a third zone front grid 133C, a third zone center grid 132C, and a third zone back grid 131C. These grid sub-assemblies can operate similarly to the grid assembly described above to electrocute an insect.

Also shown are the components of the insulator assembly 140. The insulator assembly 140 includes a front insulator assembly 145 and a back insulator assembly 145 (“outer insulator assemblies”). The insulator assembly further includes a front-internal insulator assembly 145A and a back-internal insulator assembly 144A (“inner insulator assemblies”). The front-internal insulator assembly 145A separates the front grids from the center grids. The back-internal insulator assembly 144A separates the back grids from the center grids. Further, the back-internal insulator assembly 144A separates the first zone center grid from the second zone center grid, and the second zone center grid from the third zone center grid. In other embodiments, the front-internal insulator assembly or another insulator can perform this function. The out insulator assemblies separate the outer grids from each other. That is, the front insulator assembly separates the first zone front grid from the second zone front grid, and the second zone front grid from the third zone front grid. Further, the back insulator assembly separates the first zone back grid from the second zone back grid, and the second zone back grid from the third zone back grid. In other embodiments, an alternative insulator could be used to separate the grids.

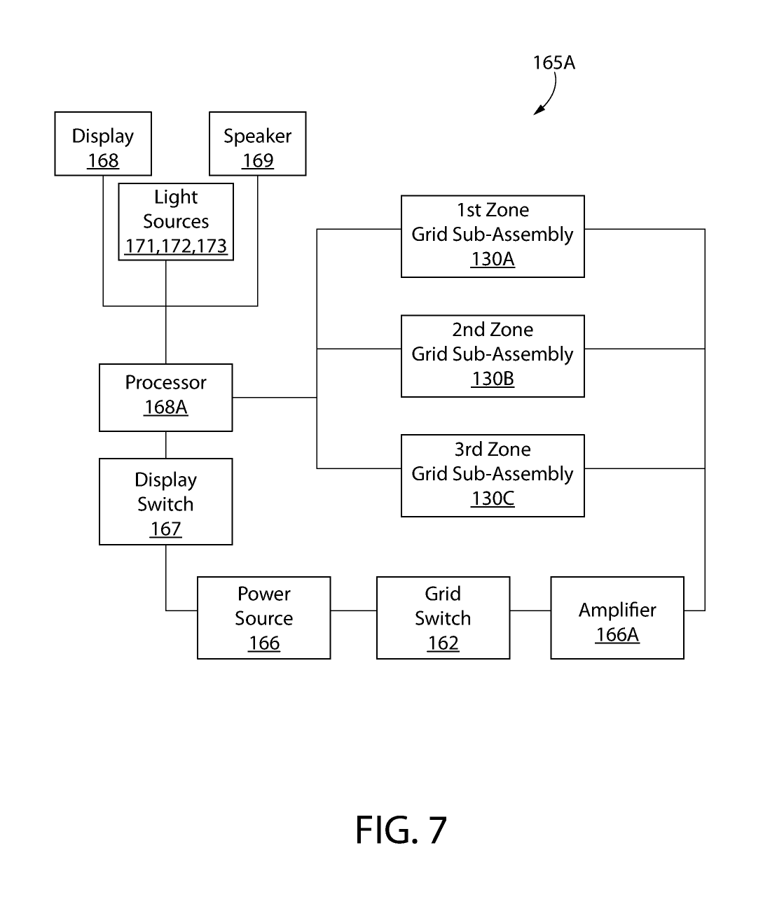

FIG. 7 is a block diagram of an electrical circuit 165A in accordance with the electronic insect killing apparatus 110 of the second embodiment of the present invention. The circuit includes a power source 166. When the grid switch 162 is activated, an amplifier 166A boosts the voltage and supplies this voltage to the center grids of the respective grid sub-assemblies. The front and back grids, by contrast, are connected with the negative terminal of the power source.

The power source 166 is connected to the processor by the display switch 167. The processor 168 is connected to each of the grid sub-assemblies 130A, 130B, 130C and can receive an indication from each grid sub-assembly that an insect has been electrocuted within that grid sub-assembly. The indication can be any electronic parameter sufficient to indicate that an insect has created a low resistance path between two of the grids of the relevant grid sub-assembly. When the processor receives this indication, it can instruct the display 168A to show an indication of how many points was scored by the kill, the points corresponding with the point value associated with the grid assembly that killed the insect. The processor can further be configured to add the score of a subsequent kill and provide an ongoing total. The processor can also provide a time limit for killing insects, or an indicator of the time elapsed since the display switch was turned on. The display could also show record high scores. A person of ordinary skill familiar with gaming devices will realize there are a variety of scores, times, records, and other information that can be provided to a user.

The processor 168 can also be connected to the light sources 171, 172, 173 and can light the number that corresponds with the location of the most recent kill. Light sources can also encircle the zones by being located in the insulating members. When a user records a kill in a zone, the processor can instruct the light sources around the relevant zone to light.

The processor can further be connected to a speaker 169 to enhance the user experience. The speaker can provide different sounds when a user causes a kill in different zones. The speaker can also provide a current score, current time, music, words of encouragement, or any other audio appropriate for the game being played.

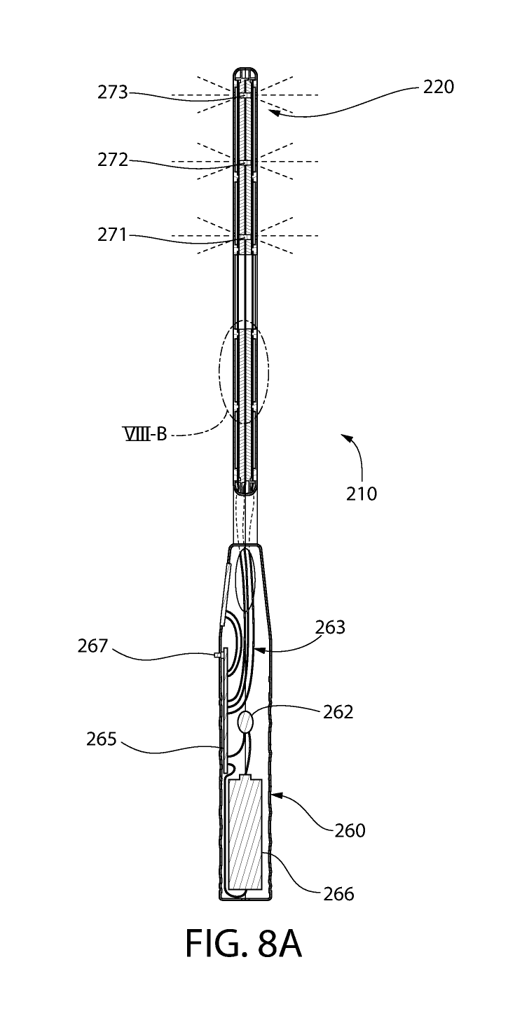

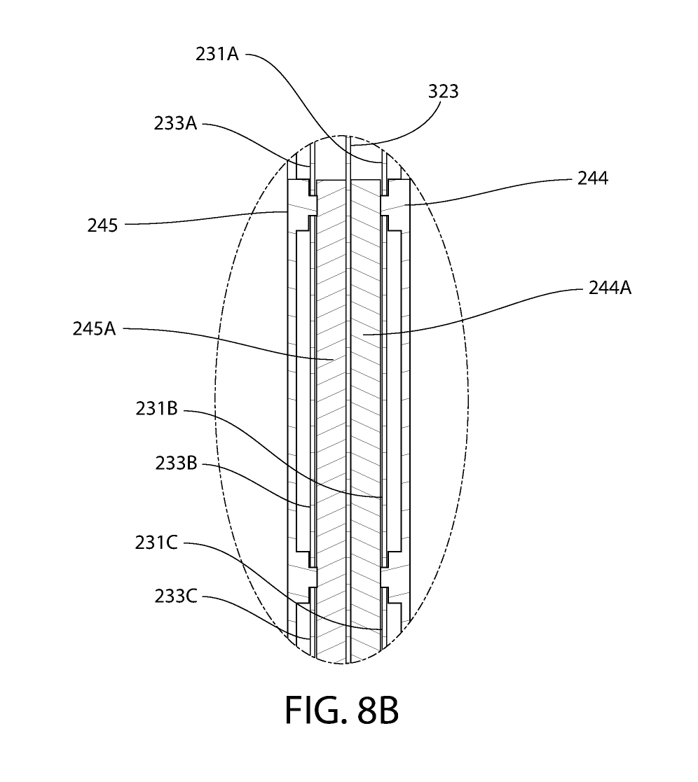

FIG. 8A-8B show an electronic insect killing apparatus 210 in accordance with a third embodiment of the present invention. This embodiment is similar to the second embodiment in several respects. For example, there is a racket assembly 220, light sources 271, 272, 273, a circuit 265, a display switch 267, wires 263, a grid switch 262, a handle 260, and a power source. Further, there is a first zone hack grid 231A, a first zone front grid 233A, a front insulator assembly 245, a front internal insulator assembly 245A, a second zone back grid 231B, a second zone front grid 233B, a third zone back grid 231C, a third zone front grid 233C, a hack insulator assembly 244, and a back internal insulator assembly 211A.

The primary difference with the second embodiment is that there is only one center grid 232. But as in the second embodiment, the processor can receive an indication from a grid sub-assembly that an insect has been electrocuted within that grid sub-assembly. The indication can be any electronic parameter sufficient to indicate that an insect has created a low resistance path between the center grid and one of the outer grids of the relevant grid sub-assembly

It should be noted that the many of the alternative structures and arrangement discussed with respect to the first embodiment could equally be applied to the second and third embodiments.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. An electronic insect killing apparatus comprising:
a handle; and
a racket assembly coupled to and extending upward from the handle, the racket assembly comprising:
a frame forming a central opening;
an electrically conductive grid assembly positioned within the central opening of the frame; and
an insulator assembly positioned within the grid assembly and comprising insulating members, the insulating members forming zones within the central opening, wherein a unique scoring indicium is associated with each zone.

2. The apparatus of claim 1 wherein the zones formed by the insulating members are concentric zones.

3. The apparatus of claim 1 wherein the racket assembly further comprises a plurality of light sources configured to light the unique scoring indicium.

4. The apparatus of claim 1 wherein the handle comprises a display.

5. The apparatus of claim 1 wherein the grid assembly comprises a first grid and a second grid, the first and second grids having differing electrical charges.

6. The apparatus of claim 1 wherein the grid assembly comprises a back grid, a center grid, and a front grid, the back grid and the center grid having differing electrical charges, and the front grid and the center grid having differing electrical charges.

7. The apparatus of claim 6 wherein the insulator assembly comprises:
a back insulator assembly separating the back grid from the center grid; and
a front insulator assembly separating the front grid from the center grid.

8. The apparatus of claim 1 wherein the grid assembly comprises three electrically conductive grid sub-assemblies, each grid sub-assembly comprising a first grid and a second grid, the first and second grids having differing electrical charges.

9. An electronic insect killing apparatus comprising:
a handle comprising a display; and
a racket assembly coupled to and extending upward from the handle, the racket assembly comprising:
a grid assembly comprising three electrically conductive grid sub-assemblies, each grid sub-assembly comprising a first grid and a second grid, the first and second grids having differing electrical charges; and
an insulator assembly comprising two insulator members, each insulator member configured to separate two of the three grid sub-assemblies, the insulating members forming zones within the racket assembly. Wherein a unique scoring indicium is associated with each zone.

10. The apparatus of claim 9 wherein the zones formed by the insulating members are concentric.

11. The apparatus of claim 9 wherein the racket assembly further comprises a plurality of light sources configured to light the unique scoring indicium.

12. The apparatus of claim 9 further comprising a processor operably coupled to the grid assembly, the processor configured to (a) receive an electrocution indication from the grid sub-assembly in which an insect has been electrocuted, and (b) instruct the display to provide a visual indication of the zone in which the insect was electrocuted.

13. The apparatus of claim 12 wherein the visual indication is based on the scoring indicium associated with the zone in which the insect was electrocuted.

14. The apparatus of claim 13 wherein the display further provides a time indication.
